(19) United States
(12) Patent Application Publication
(10) Pub. No.: US 2026/0002013 A1
(43) Pub. Date: Jan. 1, 2026

(54) SUSTAINABLE ANTIOXIDANT COMPOSITION, USE THEREOF AND POLYMER COMPOSITION COMPRISING THE SAME

(71) Applicant: BASF SE, Ludwigshafen am Rhein (DE)

(72) Inventors: Guo Liang YUAN, Shanghai (CN); Michael ISHAQUE, Shanghai (CN); Gang TENG, Shanghai (CN); Zhen WANG, Shanghai (CN)

(21) Appl. No.: 18/881,826

(22) PCT Filed: Jun. 23, 2023
(86) PCT No.: PCT/EP2023/067147

§ 371 Date: Jan. 7, 2025

(30) Foreign Application Priority Data
Jul. 13, 2022 (WO) PCT/CN2022/105434

(51) Int. Cl. C08K 5/134; C08K 5/00; C08K 5/1545; C08K 5/372

(52) U.S. Cl. CPC C08K 5/134; C08K 5/005; C08K 5/1545; C08K 5/372; C08K 2201/005; C08K 2201/019

(57) ABSTRACT

This disclosure relates to an antioxidant composition comprising component (a) and component (b), to a process for preparing an aqueous dispersion comprising the antioxidant composition, to use of the antioxidant composition as chain stopper and/or stabilizer, and to a polymer composition comprising the antioxidant composition.

### TECHNICAL FIELD

The present disclosure relates to an antioxidant composition, a process for preparing an aqueous dispersion comprising the antioxidant composition, use of the antioxidant composition as chain stopper and/or stabilizer, and a polymer composition comprising the antioxidant composition.

### BACKGROUND

Antioxidants can be used as chain stopper in free radical polymerization. Conventional antioxidants for free radical polymerization, especially PVC polymerization are either less efficient for chain stopping or having EHS issue (like BPA). And the traditional chain stoppers like ATSC (Acetone ThioSemiCarbazone), and DEHA (DiEthylHydroxylAmine) are very weak in terms of thermal stabilization for polymer, especially PVC resin. Furthermore, these chain stoppers are not easy to operate in free radical polymerization, such PVC production, as pre-dissolving in methanol or similar (toxic) organic solvents or alkali water are needed.

Therefore, there is still a need in the art to provide an antioxidant composition having excellent chain stopping property as well as excellent thermal stabilization for polymers and also being ready to use in the free radical polymerization.

### SUMMARY OF THE INVENTION

It is an object of this disclosure to provide an antioxidant composition having excellent chain stopping property as well as excellent thermal stabilization for polymers and also being ready to use in the free radical polymerization.

Another object of this disclosure is to provide a process for preparing an aqueous dispersion comprising the antioxidant composition.

A further object of this disclosure is to provide use of the antioxidant composition of this disclosure as chain stopper and/or stabilizer.

A further object of this disclosure is to provide a polymer composition comprising the antioxidant composition.

It has been surprisingly found that the above objects can be achieved by following embodiments:
1. An antioxidant composition comprising
(a) a derivative of chromanol of formula (I)

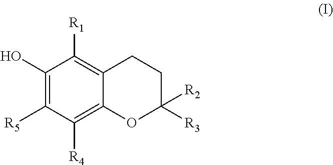

wherein
R₁ is selected from hydrogen, or an aliphatic radical having 1 to 6 carbon atoms;
R₂ is an organic radical having 1 to 30 carbon atoms; and
R₃, R₄, R₅ are selected from, independently of one another, hydrogen or C₁-C₄-alkyl; and
(b) a compound of formula (II)

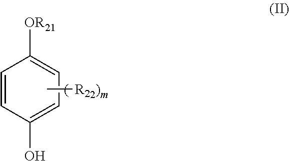

wherein
R₂₁ is C₁-C₆-alkyl,
R₂₂ is C₁-C₈-alkyl, and
m is an integer of 1, 2 or 3, with the proviso that if m is 2 or 3, at most one of the two ortho positions to hydroxyl group carries R₂₂.
2. The antioxidant composition according to item 1, wherein the composition further comprises a protective colloid and/or surfactant.
3. The antioxidant composition according to item 1 or 2, wherein R₁ is selected from hydrogen or C₁-C₆-alkyl;
preferably, R₁ is selected from hydrogen or C₁-C₄-alkyl;
more preferably, R₁ is hydrogen or C₁-C₃-alkyl;
wherein the above alkyl (C₁-C₆-alkyl, C₁-C₄-alkyl and C₁-C₃-alkyl) can optionally be interrupted by one or more non adjacent sulfur/oxygen atoms, and/or one or more non adjacent carbon atoms in the above alkyl can optionally be replaced with —(CO)—O—.
4. The antioxidant composition according to any of items 1 to 3, wherein R₂ is selected from C₁-C₃₀-alkyl, or C₂-C₃₀-alkenyl; more preferably R₂ is selected from C₈-C₃₀-alkyl, or C₈-C₃₀-alkenyl, wherein the above alkyl (C₁-C₃₀-alkyl and C₈-C₃₀-alkyl) can optionally be interrupted by one or more non adjacent sulfur/oxygen atoms, and/or one or more non adjacent carbon atoms in the above alkyl can optionally be replaced with —(CO)—O—.
5. The antioxidant composition according to any of items 1 to 4, wherein R₃, R₄, R₅ are selected from, independently of one another, hydrogen, methyl or ethyl.
6. The antioxidant composition according to any of items 1 to 5, wherein component (a) comprises α-, β-, γ-, δ-tocopherol or α-, β-, γ-, δ-tocotrienols, or mixture thereof, preferably vitamin E, more preferably a compound of formula (I′-1):

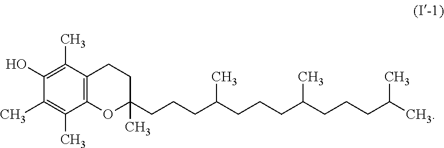 [SMILES: Cc1c(C)c2c(c(C)c1O)CCC(C)(CCCC(C)CCCC(C)CCCC(C)C)O2]

7. The antioxidant composition according to any of items 1 to 6, wherein
R₂₁ is C₁-C₄-alkyl;
R₂₂ is C₄-C₈ alkyl, preferably tertiary C₄-C₈-alkyl; and
m is an integer of 1 or 2, preferably 1, with the proviso that if m is 2, at most one of the two ortho positions to hydroxyl group carries R₂₂.
8. The antioxidant composition according to any of items 1 to 7, wherein component (b) comprises 3-tert-butyl-4-hydroxyanisole and/or 2-tert-butyl-4-hydroxyanisole, preferably comprises 3-tert-butyl-4-hydroxyanisole and 2-tert-butyl-4-hydroxyanisole in a ratio of from 100:1 to 1:20 or from 80:1 to 1:10.
9. The antioxidant composition according to any of items 1 to 8, wherein the weight ratio of component (a) to component (b) is from 5:1 to 1:5, preferably from 3:1 to 1:3, more preferably from 1:2 to 2:1.
10. The antioxidant composition according to any of items 1 to 9, wherein the composition further comprises a hindered phenol which is different from the compound of formula (I) and the compound of formula (II), a thiosynergist, or combination thereof.
11. The antioxidant composition according to any of items 1 to 10, wherein the composition is in a form of an aqueous dispersion, and average particle size (D50) of the aqueous dispersion is no more than 10 μm, preferably no more than 5 μm, more preferably no more than 2 μm.
12. The antioxidant composition according to any of items 2 to 11, wherein the composition comprises
2 to 60 wt % or 5 to 50 wt % of component (a);
2 to 60 wt % or 5 to 50 wt % of component (b);
0 to 40 wt % or 2 to 40 wt % of a hindered phenol;
0 to 30 wt % or 2 to 30 wt % of a thiosynergist;
0.2 to 12 wt % or 0.4 to 10 wt % of a protective colloid and/or a surfactant; and
water: the remainder to 100 wt %,
in each case based on the total weight of the antioxidant composition.
13. The antioxidant composition according to any of items 1 to 12, wherein the composition is substantially free of organic solvent.
14. A process for preparing an aqueous dispersion comprising the antioxidant composition according to any of items 1 to 13, which comprises homogenizing component (a) and component (b), an optional hindered phenol, an optional thiosynergist, and a protective colloid and/or surfactant in water at elevated temperature.
15. The process according to item 14, wherein when component (a), component (b), hindered phenol or thiosynergist are in solid form, the solid components are heated to melt before the homogenization, and the homogenization is carried out in water in the presence of the protective colloid and/or surfactant.
16. The process according to item 14 or 15, wherein the homogenization is carried out at a temperature higher than the melting points of component (a), component (b), and an optional hindered phenol and an optional thiosynergist.
17. Use of the antioxidant composition according to any of items 1 to 13 as chain stopper and/or stabilizer.
18. A polymer composition comprising an antioxidant composition according to any of items 1 to 13.

The advantageous technical effects brought by the antioxidant composition of this disclosure include but are not limited to:
(1) excellent chain stopping property in free radical polymerization such as PVC polymerization, even showing synergistic effect in chain stopping;
(2) excellent thermal stabilization for polymers;
(3) operation convenience (no pre-dissolving needed) as well as improving sustainability (EHS) during PVC polymerization (no toxic/organic solvent used);
(4) excellent anti-yellowness effect.
It should be understood that the part of summary of the invention is not intended to limit scope of this disclosure. Other features of this disclosure will become easily understandable in accordance with below description.

### DETAILED DESCRIPTION OF THE INVENTION

In the below description, further explanations to the present disclosure are made with reference to embodiments so as to facilitate sufficient understanding for skilled person in the art. It should be understood that these embodiments are provided merely for better understanding the subject matter of the present disclosure, not for making any limitations to the protection scope, applicability or embodiments as described in the present claims set. It should be understood that, skilled person in the art can omit, replace, or add various technical features to each embodiment based on actual needs, subject to the premise of without departing from the spirit of the present disclosure. In addition, technical features described in some embodiments can be combined with technical features described in other embodiments.

Unless defined otherwise, all technical and scientific terms used herein have the same meanings as commonly understood by skilled person in the art to which the present disclosure belongs.

In the present disclosure, terms “comprise”, “comprising”, “include”, “including” and various variants thereof can be understood as open-ended terms, which means “include but are not limited to”; in contrast, the term “consisting of” and various variants thereof excludes any component, step or procedure not specifically listed; the term “an embodiment” can be understood as “at least one embodiment”; the term “another embodiment” may be understood as “at least one other embodiment.” Other terms that may appear but are not mentioned here, unless explicitly stated, should not be interpreted or limited in a manner that is contrary to the concept on which the embodiments of the present disclosure are based.

Throughout the present disclosure, expressions “a”, “an”, “the” and “one or more” are used interchangeably and are intended to include both the plural and the singular except in cases where the singular alone is explicitly specified or is clearly indicated by the context. When the singular alone is intended for, the term “one” is typically used. The term “or” is generally intended to include the sense of “and/or” unless the content clearly dictates otherwise. “Preferred”, “preferable” and “preferably” as used herein refer to embodiments of the present disclosure that may bring certain advantages under certain situations. However, other embodiments may also be preferred, under the same situations. Further, the recitation of one or more preferred embodiments does not mean that other embodiments are not useful and is not intended to exclude other embodiments from the scope of the present disclosure.

All percentages, ppm, parts and ratios are by weight, unless otherwise specified. And the recitation of numerical ranges by end values includes all numbers subsumed within that range (e.g., 5 to 10 includes 5, 5.1, 5.2, 5.55, 6, 6.5, 7, 7.5, 8, 8.5, 9, 9.5, 10).

In the context of the present disclosure, any specific values mentioned for a feature (comprising the specific values mentioned in a range as the end point) can be re-combined to form a new range.

The term “Cₙ-Cₘ-alkyl” or “alkyl” as used herein (and also in Cₙ-Cₘ alkoxy or alkoxy, alkylthio and alkylcarbonyl) refers to a branched or unbranched saturated hydrocarbon group having n to m, e.g. 1 to 30, or 1 to 20 carbon atoms, preferably 1 to 16, or 1 to 12, or 1 to 8, or 1 to 6, 1 to 4, or 8 to 30, or 8 to 20, or 1 to 18 carbon atoms, for example methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl and their isomers. C₁-C₄-alkyl means for example methyl, ethyl, propyl, 1-methylethyl, butyl, 1-methylpropyl, 2-methylpropyl or 1,1-dimethylethyl.

The term “Cₙ-Cₘ-alkenyl” or “alkenyl” refers to a straight-chain or branched unsaturated hydrocarbon radical having n to m carbon atoms, e.g., 2 to 30, or 2 to 20 carbon atoms, preferably 2 to 16, or 2 to 12, or 2 to 8, or 2 to 6, or 2 to 4 carbon atoms and at least one (for example one, two or three) double bond in any position. Examples include ethenyl, 1-propenyl, 2-propenyl (allyl), 1-methylethenyl, 1-butenyl, 2-butenyl, 3-butenyl, 1-methyl-1-propenyl, 2-methyl-1-propenyl, 1-methyl-2-propenyl, 2-methyl-2-propenyl.

The term “Cₙ-Cₘ-alkoxy” or “alkoxy” refer to straight-chain or branched alkyl groups having n to m carbon atoms, e.g., 1 to 30, 1 to 20 carbon atoms, preferably 1 to 16, or 1 to 12, or 1 to 8, or 1 to 6, or 1 to 4 carbon atoms (as mentioned above) bonded through oxygen at any bond in the alkyl group. Examples include methoxy, ethoxy, propoxy, isopropoxy, butoxy, sec-butoxy, isobutoxy and tert-butoxy.

The term “C₃-Cₘ cycloalkyl” or “cycloalkyl” as used herein refers to a monocyclic ring of 3- to membered, for example 3- to 10-membered (or 3- to 8-membered), preferably 4- to 10-membered (4- to 8-membered), such as 4- to 7-membered (for example 4-, 5-, 6- or 7-membered) saturated cycloaliphatic radicals, e.g., cyclopropyl, cyclobutyl, cyclopentyl, cyclohexyl, cycloheptyl, cyclooctyl and cyclodecyl.

The term “aryl” as used herein refers to a mono-, bi- or tricyclic aromatic hydrocarbon radical. The aryl can comprise 6 to 10 carton atoms, such as phenyl or naphthyl, in particular phenyl (also referred as to C₆H₅ as substituent).

The term “aryloxy” refers to an aryl group as defined above, which is bonded via an oxygen atom to the remainder of the molecule, for example C₆-C₁₀-aryloxy.

The term “polymer” or “polymers”, as used herein, includes both homopolymer(s), that is, polymers prepared from a single reactive compound, and copolymer(s), that is, polymers prepared by reaction of at least two polymer forming reactive, monomeric compounds.

### Antioxidant Composition

In a first aspect, the present disclosure provides an antioxidant composition comprising
(a) a derivative of chromanol of formula (I)

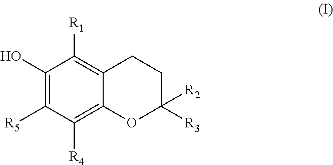

wherein
R₁ is selected from hydrogen, or an aliphatic radical having 1 to 6 carbon atoms;
R₂ is an organic radical having 1 to 30 carbon atoms; and
R₃, R₄, R₅ are selected from, independently of one another, hydrogen or C₁-C₄-alkyl; and
(b) a compound of formula (II)

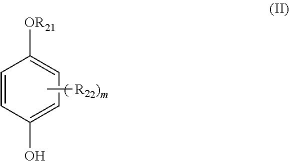

wherein
R₂₁ is C₁-C₆-alkyl,
R₂₂ is C₁-C₈-alkyl, and
m is an integer of 1, 2 or 3, with the proviso that if m is 2 or 3, at most one of the two ortho positions to hydroxyl group carries R₂₂.

In an embodiment, the aliphatic radical having 1 to 6 carbon atoms mentioned for R₁ in the compound of formula (I) can have 1, 2, 3, 4, 5 or 6 carbon atoms, for example 1 to 4, 1 to 3, 1 to 2 carbon atoms. In an embodiment, the aliphatic radical having 1 to 6 carbon atoms mentioned for R₁ can be selected from alkyl, wherein the above alkyl can optionally be interrupted by one or more non adjacent sulfur/oxygen atoms, and/or one or more non adjacent carbon atoms in the above alkyl can optionally be replaced with —(CO)—O—.

In the compound of formula (I), R₁ can be selected from hydrogen or C₁-C₆-alkyl, wherein the above C₁-C₆-alkyl can optionally be interrupted by one or more non adjacent sulfur/oxygen atoms, and/or one or more non adjacent carbon atoms in the above alkyl can optionally be replaced with —(CO)—O—.

In the compound of formula (I), R₁ can be selected from hydrogen or C₁-C₄-alkyl (for example methyl, ethyl, propyl or butyl), wherein the above C₁-C₄-alkyl can optionally be interrupted by one or more non adjacent sulfur/oxygen atoms, and/or one or more non adjacent carbon atoms in the above alkyl can optionally be replaced with —(CO)—O—.

In an embodiment, the organic radical having 1 to 30 carbon atoms mentioned for R₂ in the compound of formula (I) can have 2 to 30 (for example 2, 4, 6, 8, 10, 12, 14, 16, 18, 20, 22, 24, 26, 28 and 30), 6 to 30, 8 to 30, 8 to 22, 10 to 22 carbon atoms. In an embodiment, the R₂ is a hydrocarbyl. In an embodiment, R₂ is a linear or branched hydrocarbyl.

In an embodiment, wherein R₂ is selected from C₁-C₃₀-alkyl, or C₂-C₃₀-alkenyl; more preferably
R₂ is selected from C₈-C₃₀-alkyl, or C₈-C₃₀-alkenyl. In an embodiment, R₂ is selected from C₈-C₂₂-alkyl, or C₈-C₂₂-alkenyl. In an embodiment, R₂ is selected from C₁₀-C₂₂-alkyl, or C₁₀-C₂₂-alkenyl. In an embodiment, the alkenyl mentioned for R₂ can have 1 to 3 double bonds, for example 1, 2 or 3 double bonds. The above alkyl (C₁-C₃₀-alkyl and C₈-C₃₀-alkyl) can optionally be interrupted by one or more non adjacent sulfur/oxygen atoms, and/or one or more non adjacent carbon atoms in the above alkyl can optionally be replaced with —(CO)—O—.

In the compound of formula (I), R₃, R₄, R₅ are selected from, independently of one another, hydrogen or C₁-C₄-alkyl. In a preferred embodiment, R₃, R₄, R₅ are selected from, independently of one another, hydrogen, methyl or ethyl, preferably hydrogen or methyl.

In an embodiment, the variables in the compound of formula (I) have the following meanings:
R₁ is selected from hydrogen or C₁-C₆-alky;
R₂ is selected from C₁-C₃₀-alkyl, or C₂-C₃₀-alkenyl; and
R₃, R₄, R₅ are selected from, independently of one another, hydrogen or C₁-C₄-alkyl; wherein the above alkyl (C₁-C₆-alkyl and C₁-C₃₀-alkyl) can optionally be interrupted by one or more non adjacent sulfur/oxygen atoms, and/or one or more non adjacent carbon atoms in the above alkyl can optionally be replaced with —(CO)—O—.

In an embodiment, the variables in the compound of formula (I) have the following meanings:
R₁ is selected from hydrogen or C₁-C₃-alkyl;
R₂ is selected from C₈-C₃₀-alkyl, or C₈-C₃₀-alkenyl; and
R₃, R₄, R₅ are selected from, independently of one another, hydrogen, methyl or ethyl;
wherein the above alkyl (C₁-C₃-alkyl and C₈-C₃₀-alkyl) can optionally be interrupted by one or more non adjacent sulfur/oxygen atoms, and/or one or more non adjacent carbon atoms in the above alkyl can optionally be replaced with —(CO)—O—.

In an embodiment, the variables in the compound of formula (I) have the following meanings:
R₁ is selected from hydrogen or C₁-C₂-alkyl;
R₂ is selected from C₈-C₂₂-alkyl, or C₈-C₂₂-alkenyl; and
R₃, R₄, R₅ are selected from, independently of one another, hydrogen or methyl;
wherein the above alkyl (C₈-C₂₂-alkyl) can optionally be interrupted by one or more non adjacent sulfur/oxygen atoms, and/or one or more non adjacent carbon atoms in the above alkyl can optionally be replaced with —(CO)—O—.

In an embodiment, at least one (i.e., one or two) of R₁ and R₅ is not hydrogen. In an embodiment, at least one (i.e., one or two) of R₁ and R₅ is methyl. In an embodiment, both R₁ and R₅ are methyl.

In an embodiment, the compound of formula (I) comprises a compound of formula (I′):

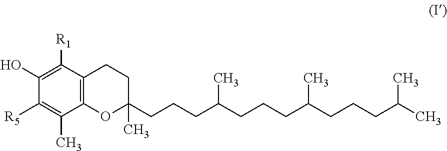

wherein
R₁ and R₅ are independently of each other H or C₁-alkyl (i.e., methyl).

In an embodiment, R₁ and R₅ in formula (I′) are C₁-alkyl (i.e., methyl).

The compound of formula (I′) possesses three asymmetric carbon atoms at positions 2, 4′ and 8′ in its chemical structure. All combinations of R and S configurations at the single asymmetric carbon atoms are covered, including also mixtures of enantiomers and diastereomers, for example racemic mixtures. A compound of formula (I′) is for example α-tocopherol, i.e. R₁ is C₁-alkyl, R₅ is C₁-alkyl and the configuration 2R, 4′R and 8′R, β-tocopherol, i.e. R₁ is C₁-alkyl, R₅ is hydrogen and the configuration 2R, 4′R and 8′R, γ-tocopherol, i.e. R₁ is hydrogen, R₅ is C₁-alkyl and the configuration 2R, 4′R and 8′R, or δ-tocopherol, i.e. R₁ is hydrogen, R₅ is hydrogen and the configuration 2R, 4′R and 8′R. Mixtures of compound of formula (I′) are also suitable, for example, natural vitamin E or industrially synthesized vitamin E contains compounds of formula (I′). Preferably, at least one of R₁ and R₅ is C₁-alkyl. In particular, R₁ and R₅ are C₁-alkyl.

In an embodiment, the compound of formula (I) (component (a)) is selected from tocopherols, tocotrienols, and mixtures thereof. Tocopherols can include for example α-, β-, γ- and δ-tocopherols. Tocotrienols can include for example α-, β-, γ- and δ-tocotrienols.

In an embodiment, component (a) comprises α-, β-, γ-, δ-tocopherols or α-, β-, γ-, δ-tocotrienols, or mixture thereof.

In an embodiment, the compound of formula (I) (component (a)) is Vitamin E. Vitamin E contains natural source Vitamin E and synthetic source Vitamin E. In an embodiment, the Vitamin E is synthesized and is a mixture of stereoisomers.

In an embodiment, the compound of formula (I) (component (a)) is a compound of formula (I′-1):

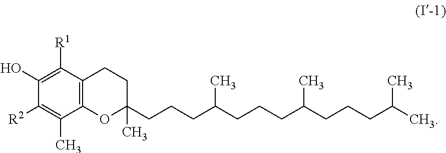

The compound of formula (I′-1) contains three asymmetric carbon atoms at positions 2, 4′ and 8′ in its chemical structure. All combinations of R and S configurations at the single asymmetric carbon atoms are covered, including also mixtures of enantiomers and diastereomers, for example racemic mixtures. In an embodiment, component (a) is a racemic mixture of stereoisomers of formula (I′-1).

The amount of component (a) can be in the range from 2 to 60 wt %, for example 2 wt %, 4 wt %, 5 wt %, 6 wt %, 8 wt %, 10 wt %, 15 wt %, 20 wt %, 25 wt %, 30 wt %, 35 wt %, 40 wt %, 50 wt %, or 60 wt %, preferably from 5 to 50 wt %, or from 6 to 40 wt %, or from 8 to 30 wt %, based on the total weight of the antioxidant composition.

In an embodiment, the variables in the compound of formula (II) have the following meanings:
R₂₁ is C₁-C₄-alkyl;
R₂₂ is C₄-C₈ alkyl, preferably tertiary C₄-C₈-alkyl; and
m is an integer of 1 or 2, preferably 1, with the proviso that if m is 2, at most one of the two ortho positions to hydroxyl group carries R₂₂.

In an embodiment, the variables in the compound of formula (II) have the following meanings:
R₂₁ is C₁-C₂-alkyl;
R₂₂ is tertiary C₄-C₆-alkyl; and
m is an integer of 1 or 2, preferably 1, with the proviso that if m is 2, at most one of the two ortho positions to hydroxyl group carries R₂₂.

In the compound of formula (II), if m is 2 or 3, the R₂₂ can be the same or different.

In an embodiment, one of the two ortho positions to hydroxyl group carries R₂₂, i.e., the other ortho position does not carry R₂₂.

In an embodiment, the compound of formula (II) is selected from 3-tert-butyl-4-hydroxyanisole and 2-tert-butyl-4-hydroxyanisole.

In an embodiment, component (b) comprises 3-tert-butyl-4-hydroxyanisole. In an embodiment, component (b) comprises 2-tert-butyl-4-hydroxyanisole. In an embodiment, component (b) comprises 3-tert-butyl-4-hydroxyanisole and/or 2-tert-butyl-4-hydroxyanisole.

In an embodiment, component (b) comprises or consists of 3-tert-butyl-4-hydroxyanisole and 2-tert-butyl-4-hydroxyanisole. The ratio of 3-tert-butyl-4-hydroxyanisole to 2-tert-butyl-4-hydroxyanisole can be in the range from 100:1 to 1:20 (for example 100:1, 80:1, 50:1, 20:1, 10:1, 5:1, 2:1, 1:1, 1:2, 1:5, 1:10, 1:20), or from 80:1 to 1:10, or from 50:1 to 1:1, or from 50:1 to 2:1.

In an embodiment, component (a) comprises or is vitamin E and/or component (b) comprises or consists of 3-tert-butyl-4-hydroxyanisole and optional 2-tert-butyl-4-hydroxyanisole, more preferably component (a) is vitamin E and component (b) consists of 3-tert-butyl-4-hydroxyanisole and 2-tert-butyl-4-hydroxyanisole.

In an embodiment, component (a) is a compound of formula (I′-1) and component (b) consists of 3-tert-butyl-4-hydroxyanisole and 2-tert-butyl-4-hydroxyanisole.

The amount of component (b) can be in the range from 2 to 60 wt %, for example 2 wt %, 4 wt %, 5 wt %, 6 wt %, 8 wt %, 10 wt %, 15 wt %, 20 wt %, 25 wt %, 30 wt %, 35 wt %, 40 wt %, 50 wt %, or 60 wt %, preferably from 5 to 50 wt %, or from 6 to 40 wt %, or from 8 to 30 wt %, based on the total weight of the antioxidant composition.

In the antioxidant composition of this disclosure, the weight ratio of component (a) to component (b) can be from 10:1 to 1:10 (for example 10:1, 9:1, 8:1, 7:1, 6:1, 5:1, 4:1, 3:1, 2:1, 1.5:1, 1:1, 1:1.5, 1:2, 1:3, 1:4, 1:5, 1:6, 1:7, 1:8, 1:9, or 1:10), preferably from 8:1 to 1:8, more preferably from 5:1 to 1:5 or from 1:3 to 3:1, for example from 1:1.5 to 1:3 or from 3:1 to 1.5:1.

### Hindered Phenol

In an embodiment, the antioxidant composition of this disclosure further comprises a hindered phenol, i.e., sterically hindered phenol, which is different from the compound of formula (I) and the compound of formula (II).

The hindered phenol includes phenols that have one or more phenolic hydroxyl groups on the aromatic ring, and preferably those that have a substituent, preferably an alkyl group, in the ortho positions, most preferably in the ortho and para positions, to the phenolic hydroxyl group(s).

It should be understood that above description is not intended to limit the scope of hindered phenols that are suitable for the present disclosure. The present disclosure has no limitation on the sterically hindered phenols as long as they have antioxidant properties.

Examples of suitable hindered phenols include alkylphenols, for example, o-, m- or p-cresol (methylphenol), 2-tert-butyl-4-methylphenol, 6-tert-butyl-2,4-dimethylphenol, 2,6-di-tert-butyl-4-methylphenol, 2-tert-butylphenol, 4-tert-butylphenol, 2,4-di-tert-butylphenol, 2-methyl-4-tertbutylphenol, 4-tert-butyl-2,6-dimethylphenol, or 2,2′-methylenebis(6-tert-butyl-4-methylphenol), 4,4′-oxydiphenol, 3,4-methylenedioxydiphenol (sesamol), 3,4-dimethylphenol, hydroquinone, tert-butylhydroquinone, 2,5-di-tert-butylhydroquinone, 2-methyl-p-hydroquinone, 2,3-dimethylhydroquinone, trimethylhydroquinone, pyrocatechol (1,2-dihydroxybenzene), 2-(1′-methylcyclohex-1′-yl)-4,6-dimethylphenol, 2- or 4-(1′-phenyleth-1′-yl) phenol, 2-tert-butyl-6-methylphenol, 2,4,6-tris-tert-butylphenol, 2,6-di-tert-butylphenol, nonylphenol [11066-49-2], octylphenol [140-66-9], 2,6-dimethylphenol, bisphenol A, bisphenol F, bisphenol B, bisphenol C, bisphenol S, 3,3′,5,5′-tetrabromobisphenol A, Koresin® from BASF AG, methyl 3,5-di-tert-butyl-4-hydroxybenzoate, 4-tert-butylpyrocatechol, 2-hydroxybenzyl alcohol, 2-methoxy-4-methylphenol, 2,3,6-trimethylphenol, 2,4,5-trimethylphenol, 2,4,6-trimethylphenol, 2-isopropylphenol, 4-isopropylphenol, 6-isopropyl-m-cresol, n-octadecyl β-(3,5-di-tert-butyl-4-hydroxyphenyl) propionate, 1,1,3-tris-(2-methyl-4-hydroxy-5-tert-butylphenyl) butane, 1,3,5-trimethyl-2,4,6-tris(3,5-di-tert-butyl-4-hydroxybenzyl)benzene, 1,3,5-tris-(3,5-di-tert-butyl-4-hydroxybenzyl) isocyanurate, 1,3,5,-tris-(3,5-di-tert-butyl-4-hydroxyphenyl) propionyloxyethyl isocyanurate, 1,3,5-tris-(2,6-dimethyl-3-hydroxy-4-tert-butylbenzyl) isocyanurate or pentaerythritol tetrakis[β-(3,5,-di-tert-butyl-4-hydroxyphenyl) propionate], 2,6-di-tert-butyl-4-dimethylaminomethylphenol, 6-isobutyl-2,4-dinitrophenol, 6-sec-butyl-2,4-dinitrophenol, 2,6-ditert-butyl-4-(4,6-bis (octylthio)-1,3,5-triazin-2-ylamino) phenol, octadecyl 3-(3′,5′-di-tert-butyl-4′-hydroxyphenyl) propionate, hexadecyl 3-(3′,5′-di-tert-butyl-4′-hydroxyphenyl) propionate, octyl 3-(3′,5′-di-tert-butyl-4′-hydroxyphenyl) propionate, 3-thia-1,5-pentanediol bis[(3′,5′-di-tert-butyl-4′-hydroxyphenyl) propionate], 4,8-dioxa-1,11-undecanediol bis[(3′,5′-di-tert-butyl-4′-hydroxyphenyl) propionate], 4,8-dioxa-1,11-undecanediol bis[(3′-tert-butyl-4′-hydroxy-5′-methylphenyl) propionate], 1,9-nonanediol bis[(3′,5′-di-tert-butyl-4′-hydroxyphenyl) propionate], 1,7-heptanediaminebis[3-(3′,5′-di-tert-butyl-4′-hydroxyphenyl) propionamide], 1,1-methanediaminebis[3-(3′,5′-di-tert-butyl-4′-hydroxyphenyl) propionamide], 3-(3′,5′-di-tert-butyl-4′-hydroxyphenyl) propionoic hydrazide, 3-(3′,5′-dimethyl-4′-hydroxyphenyl) propionoic hydrazide, bis(3-tert-butyl-5-ethyl-2-hydroxyphen-1-yl) methane, bis(3,5-di-tert-butyl-4-hydroxyphen-1-yl) methane, bis[3-(1′-methylcyclohex-1′-yl)-5-methyl-2-hydroxyphen-1-yl]methane, bis(3-tertbutyl-2-hydroxy-5-methylphen-1-yl) methane, 1,1-bis(5-tert-butyl-4-hydroxy-2-methylphen-1-yl) ethane, bis(5-tert-butyl-4-hydroxy-2-methylphen-1-yl) sulfide, bis(3-tert-butyl-2-hydroxy-5-methylphen-1-yl) sulfide, 1,1-bis(3,4-dimethyl-2-hydroxyphen-1-yl)-2-methylpropane, 1,1-bis(5-tert-butyl-3-methyl-2-hydroxyphen-1-yl) butane, 1,3,5-tris[1′-(3″,5″-di-tert-butyl-4″-hydroxyphen-1″-yl)-meth-1′-yl]-2,4,6-trimethylbenzene, 1,1,4-tris (5′-tert-butyl-4′-hydroxy-2′-methylphen-1′-yl) butane, aminophenols, such as para-aminophenol, 3-diethylaminophenol, nitrosophenols, such as para-nitrosophenol, p-nitroso-o-cresol, alkoxyphenols, such as 2-methoxyphenol (Guajacol, pyrocatechol monomethyl ether), 4-methoxyphenol (hydroquinone monomethyl ether), 2-ethoxyphenol, 4-ethoxyphenol, 2-isopropoxyphenol, 4-butoxyphenol, mono- or di-tertbutyl-4-methoxyphenol, 3,5-di-tert-butyl-4-hydroxyanisole, 3-hydroxy-4-methoxybenzyl alcohol, 2,5-dimethoxy-4-hydroxybenzyl alcohol (syringa alcohol), 4-hydroxy-3-methoxybenzaldehyde (vanillin), 4-hydroxy-3-ethoxybenzaldehyde (ethyl vanillin), 3-hydroxy-4-methoxybenzaldehyde (isovanillin), 1-(4-hydroxy-3-methoxyphenyl) ethanone (acetovanillon), eugenol, dihydroeugenol, isoeugenol, tocol, α-tocopherolhydroquinone, 4-methylpyrocatechol, 3-methylpyrocatechol, hydroquinone monobenzyl ether, p-phenoxyphenol, 2,5-di-tert-amylhydroquinone, 2,3-dihydro-2,2-dimethyl-7-hydroxybenzofuran (2,2-dimethyl-7-hydroxycoumaran), 6-hydroxy-2,5,7,8-tetramethylchroman-2-carboxylic acid (Trolox®), butylated products of p-cresol and dicyclopentadiene, and derivatives thereof.

Corresponding sterically hindered phenol products are available, for example, under the trade names Irganox® (BASF), such as pentaerythritol tetrakis[β-(3,5,-di-tert-butyl-4-hydroxyphenyl) propionate] (e.g., Irganox® 1010), 1,3,5-tris(3,5-di-tert-butyl-4-hydroxybenzyl)-1,3,5-triazine-2,4,6(1H,3H,5H) trione (e.g., Irganox® 3114), thiodiethylenebis[3-[3,5-di-tert-butyl-4-hydroxyphenyl]propionate] (e.g., Irganox® 1035), 3,5-bis(1,1-dimethylethyl)-4-benzenepropanoic acid, branched C₇-C₉-alkyl ester (e.g., Irganox® 1135), octadecyl 3-(3,5-ditert-butyl-4-hydroxyphenyl) propionate (e.g., Irganox® 1076), esters of polyglycol ether terminated with phenol derivatives (e.g., Irganox® 2000), 4,6-bis(octylthiomethyl)-o-cresol (e.g., Irganox® 1520); 3,5-bis(1,1-dimethylethyl)-4-hydroxy-benzenepropanoic acid, branched C₁₃-C₁₅-alkyl esters (e.g., Anox® 1315), butylated products of p-cresol and dicyclopentadiene (Wingstay L).

In an embodiment, the hindered phenol comprises or consists of octadecyl-3-[3,5-di-tert-butyl-4-hydroxyphenyl]propionate and butylated products of p-cresol and dicyclopentadiene (Wingstay L), preferably in a ratio of from 10:1 to 1:10, or from 5:1 to 1:5, or from 1:3 to 3:1, or from 2:1 to 1:2, or 1:1.

The amount of hindered phenol can be in the range from 0 to 40 wt % or from 2 to 40 wt %, for example 2 wt %, 4 wt %, 5 wt %, 6 wt %, 8 wt %, 10 wt %, 15 wt %, 20 wt %, 25 wt %, 30 wt %, 35 wt % or 40 wt %, or from 0 to 30 wt % or from 2 to 30 wt %, or from 0 to 25 wt % or from 4 to 25 wt %, based on the total weight of the antioxidant composition.

### Thiosynergist

In an embodiment, the antioxidant composition of this disclosure further comprises a thiosynergist. The thiosynergist can comprises thioether and/or thioester.

Thioether used according to the present disclosure includes compounds which comprise at least one thioether group, i.e. a sulfur atom which is substituted by two identical or different organic substituents. The organic substituents can each comprises 1 to 20, or 1 to 18, or 1 to 12 carbon atoms. It should be understood that the above description is not intended to limit the scope of thioethers of the present disclosure. The present disclosure has no limitation on the thioether.

Suitable thioethers have a structure of formula (III)

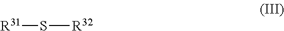

wherein
R₃₁ and R₃₂ can each be, independently of one another, C₁-C₁₈-alkyl, C₂-C₁₈-alkyl which is interrupted by one or more oxygen and/or sulfur atoms and/or one or more substituted or unsubstituted imino groups, C₂-C₁₈-alkenyl, C₆-C₁₂-aryl, C₅-C₁₂-cycloalkyl or a five- or six-membered, oxygen-, nitrogen- and/or sulfur-comprising heterocycle, wherein the radicals mentioned are optionally substituted by hydroxy, amino, aryl, alkyl, aryloxy, alkyloxy, alkylthio, alkoxycarbonyl, nitro, acyl, carbocycles, heteroatoms and/or heterocycles.

Here, R₃₁ and R₃₂ can each be, independently of one another, selected from a group consisting of the following groups:
methyl, ethyl, n-propyl, isopropyl, n-butyl, sec-butyl, tert-butyl, n-pentyl, n-hexyl, n-heptyl, n-octyl, 2-ethylhexyl, 2,4,4-trimethylpentyl, n-decyl, n-dodecyl, n-tetradecyl, n-hetadecyl, n-octadecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonethyl, 2-ethoxycarbonylethyl, 2-butoxycarbonylpropyl, 1,2-di (methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxypropyl, 3-methoxypropyl, 4-methoxybutyl, 6-methoxyhexyl, 2-ethoxypropyl, 3-ethoxypropyl, 4-ethoxybutyl or 6-ethoxyhexyl;
5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl;
vinyl, 1-propenyl, allyl, methallyl, 1,1-dimethylallyl, 2-butenyl, 2-hexenyl, octenyl, undecenyl, dodecenyl, octadecenyl, 2-phenylvinyl, 2-methoxyvinyl, 2-ethoxyvinyl, 2-methoxyallyl, 3-methoxyallyl, 2-ethoxyallyl, 3-ethoxyallyl or 1- or 2-chlorovinyl;
phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl;
cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl; and
furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl.

In some embodiments, the thioether is selected from a group consisting of 2-methyl-1-propenyl tert-dodecyl thioether, cyclohexylidenemethyl n-dodecyl thioether, 3-cyclohexen-(1)ylidenemethyl-n-octadecyl thioether, 3-cyclohexen-(1)-ylidenemethyl-n-dodecyl thioether, 3-cyclohexen-(1)-ylidenemethyl n-octyl thioether, 3-cyclohexen-(1)-ylidenemethyl cyclohexyl thioether, 3-methyl-(3)-cyclohexen-(1)-ylidenemethyl n-dodecyl thioether, 3-cyclohexen-(1)ylidenemethyl p-tolyl thioether, 3-cyclohexen-(1)-ylidenemethyl benzyl thioether and preferably 3-cyclohexen-(1)-ylidenemethyl n-dodecyl thioether and 1-hexenyl-n-dodecyl thioether.

In other embodiments, thioethers are compounds that have a structure of formula (IV)

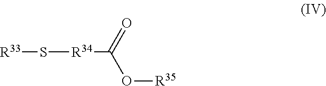

wherein
R₃₃ and R₃₅ can each be, independently of one another, C₁-C₁₈-alkyl, C₂-C₁₈-alkyl, which is interrupted by one or more oxygen and/or sulfur atoms and/or one or more substituted or unsubstituted imino groups, C₆-C₁₂-aryl or C₅-C₁₂-cycloalkyl, wherein the radicals mentioned are optionally substituted by hydroxy, amino, aryl, alkyl, aryloxy, alkyloxy, alkylthio, alkoxycarbonyl, nitro, acyl, carbocycles, heteroatoms and/or heterocycles, and
R₃₄ can be C₁-C₂₀-alkylene or C₃-C₁₂-cycloalkylene, wherein the radicals mentioned are optionally substituted by hydroxy, amino, aryl, alkyl, aryloxy, alkyloxy, alkylthio, alkoxycarbonyl, nitro, acyl, carbocycles, heteroatoms and/or heterocycles.

Here, R₃₃ and R₃₅ can each be, independently of one another, selected from a group consisting of the following groups:
methyl, ethyl, n-propyl, isopropyl, n-butyl, sec-butyl, tert-butyl, n-pentyl, n-hexyl, n-heptyl, n-octyl, 2-ethylhexyl, 2,4,4-trimethylpentyl, n-decyl, n-dodecyl, n-tetradecyl, n-hetadecyl, n-octadecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonethyl, 2-ethoxycarbonylethyl, 2-butoxycarbonylpropyl, 1,2-di (methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxypropyl, 3-methoxypropyl, 4-methoxybutyl, 6-methoxyhexyl, 2-ethoxypropyl, 3-ethoxypropyl, 4-ethoxybutyl or 6-ethoxyhexyl;
5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl;
phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl; and cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

Here, R₃₄ can be selected from a group consisting of the following groups:
methylene, 1,2-ethylene, 1,2- or 1,3-propylene, 1,2-, 1,3- or 1,4-butylene, 1,1-dimethyl-1,2-ethylene or 1,2-dimethyl-1,2-ethylene, 1,6-hexylene, 1,8-octylene, 1,10-decylene, 1,12-dodecylene and 1,20-eicosylene, and
cyclopropylene, cyclopentylene, cyclohexylene, cyclooctylene and cyclododecylene.

In some preferred embodiments, R₃₃ is optionally substituted C₆-C₁₂-aryl or C₁-C₁₈-alkyl, preferably optionally substituted C₁-C₁₈-alkyl, particularly preferably unsubstituted C₁-C₁₈-alkyl;
R₅ is optionally substituted C₁-C₁₈-alkyl, preferably unsubstituted C₁-C₁₈-alkyl; and/or R₄ is methylene, 1,2-ethylene or 1,2-propylene, preferably 1,2-ethylene.

In some embodiments, especial preference is given to compounds having a structure of formula (V)

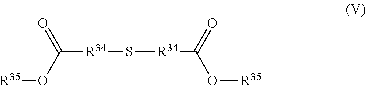

wherein R₃₄ and R₃₅ are as defined above.

In preferable embodiments, the thioether is at least one selected from a group consisting of thiodipropionic esters, for example dimethyl 3,3′-thiodipropionate, didodecyl 3,3′-thiodipropionate (e.g., Irganox® PS 800 from BASF), di-lauryl-thio-di-propionate (DLTDP), ditridecyl 3,3′-thiodipropionate (DTDTP) (e.g., Songnox® DTDTP from Songwon International AG), dioctadecyl 3,3′-thiodipropionate (DSTDP), dimyristyl thiodipropionate (DMTDP) and 2,2-bis[[3-(dodecylthio)-1-oxopropoxy]methyl]propane-1,3-diyl bis[3-(dodecylthio) propionate] (e.g., Seenox 412S).

Thioester can include for example dilauryl thiodipropionate, dimistryl thiodipropionate or distearyl thiodipropionate.

In an embodiment, the thiosynergist comprises or consisted of di-lauryl-thio-di-propionate (DLTDP).

The amount of thiosynergist can be in the range from 0 to 30 wt % or from 2 to 30 wt %, for example 2 wt %, 4 wt %, 5 wt %, 6 wt %, 8 wt %, 10 wt %, 15 wt %, 20 wt %, 25 wt %, 30 wt %, or from 0 to 25 wt % or from 2 to 25 wt %, or from 0 to 20 wt % or from 4 to 20 wt %, based on the total weight of the antioxidant composition.

In an embodiment, the antioxidant composition comprises component (a), component (b), the hindered phenol which is different from the compound of formula (I) and the compound of formula (II) and the thiosynergist.

The ratio of the sum of component (a) and component (b) to the sum of said hindered phenol and the thiosynergist can be in range from 10:1 to 1:100 (for example 10:1, 8:1, 5:1, 2:1, 1:1, 1:2, 1:5, 1:10, 1:20, 1:50, 1:80 or 1:100), preferably from 5:1 to 1:80, or from 2:1 to 1:50. The ratio of said hindered phenol to the thiosynergist can be in range from 10:1 to 1:10 (for example 8:1, 5:1, 2:1, 1:1, 1:2, 1:5, 1:8, or 1:10), preferably from 5:1 to 1:5, or from 3:1 to 1:3.

Protective Colloid and/or Surfactant

In an embodiment, the antioxidant composition further comprises a protective colloid and/or a surfactant.

Examples of suitable protective colloids are polyvinyl alcohols, starch derivatives and cellulose derivatives, or vinyl pyrrolidone copolymers. A detailed description of further suitable protective colloids is given in Houben-Weyl, Methoden der Organischen Chemie, Volume XIV/1, Makromolekulare Stoffe [macromolecular substances], Georg-Thieme-Verlag, Stuttgart 1961, pp. 411-420.

The surfactant can be selected from nonionic, anionic and/or cationic surfactant, preferably nonionic surfactant.

Suitable nonionic surfactants (b) can include:
Alkoxylated C₈-C₂₂ alcohols, such as fatty alcohol alkoxylates, oxo alcohol alkoxylates and Guerbet alcohol ethoxylates: the alkoxylation can be carried out with ethylene oxide, propylene oxide and/or butylene oxide. Block copolymers or random copolymers may be present. Per mole of alcohol, they usually comprise 2 to 50 mol, preferably 3 to 20 mol, of at least one alkylene oxide. A preferred alkylene oxide is ethylene oxide. The alcohols preferably have 10 to 18 carbon atoms.
Alkylphenol alkoxylates, in particular alkylphenol ethoxylates, which comprise C₆-C₁₄-alkyl chains and 5 to 30 mol of alkylene oxide/mol.
Alkyl polyglucosides which comprise C₈-C₂₂-, preferably C₁₀-C₁₈-, alkyl chains and usually 1 to 20, preferably 1.1 to 5, glucoside units.
N-Alkylglucamides, fatty acid amide alkoxylates, fatty acid alkanolamide alkoxylates, and block copolymers of ethylene oxide, propylene oxide and/or butylene oxide.

Suitable anionic surfactants are, for example:
Sulfates of (fatty) alcohols having 8 to 22, preferably 10 to 18, carbon atoms, in particular C₉C₁₁-alcohol sulfates, C₁₂C₁₄-alcohol sulfates, C₁₂-C₁₈-alcohol sulfates, lauryl sulfate, cetyl sulfate, myristyl sulfate, palmityl sulfate, stearyl sulfate and tallow fatty alcohol sulfate.
Sulfated alkoxylated C₈-C₂₂-alcohols (alkyl ether sulfates): compounds of this type are prepared, for example, by firstly alkoxylating a C₈-C₂₂-, preferably a C₁₀-C₁₈-, alcohol, e.g. a fatty alcohol, and then sulfating the alkoxylation product. For the alkoxylation, preference is given to using ethylene oxide.
Linear C₈-C₂₀-alkylbenzenesulfonate (LAS), preferably linear C₉-C₁₃-alkylbenzenesulfonates and -alkyltoluenesulfonates.
Alkanesulfonates, in particular C₈-C₂₄-, preferably C₁₀-C₁₈-, alkanesulfonates.
Soaps, such as the Na and K salts of C₈-C₂₄-carboxylic acids.

The anionic surfactants are added to the detergent preferably in the form of salts. Suitable salts in this connection are, for example, alkali metal salts, such as sodium, potassium and lithium salts, and ammonium salts, such as hydroxyethylammonium, di (hydroxyethyl) ammonium and tri (hydroxyethyl) ammonium salts.

Suitable cationic surfactants which may be mentioned are:
C₇-C₂₅-alkylamines;
N,N-dimethyl-N-(hydroxy-C₇-C₂₅-alkyl) ammonium salts;
mono- and di-(C₇-C₂₅-alkyl)dimethylammonium compounds quaternized with alkylating agents;
ester quats, in particular quaternary esterified mono-, di- and trialkanolamines esterified with C₈-C₂₂-carboxylic acids;
imidazoline quats, in particular 1-alkylimidazolinium salts of the formulae (VI) or (VII)

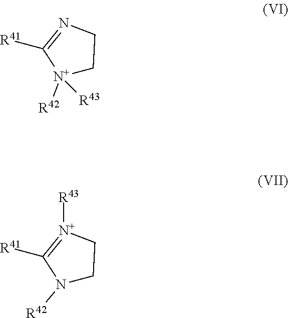

in which the variables have the following meanings:
R₄₁ is C₁-C₂₅-alkyl or C₂-C₂₅-alkenyl;
R₄₂ is C₁-C₄-alkyl or hydroxy-C₁-C₄-alkyl;
R₄₃ is C₁-C₄-alkyl, hydroxy-C₁-C₄-alkyl or a radical R₄₄—(CO)—X—(CH₂)ₚ— (X: —O— or —NH—; p: 2 or 3),
where at least one radical R₄₄ is C₇-C₂₂-alkyl.

The amount of protective colloid and/or surfactant can be in the range from 0.2 to 12 wt %, for example 0.2 wt %, 0.4 wt %, 0.5 wt %, 0.6 wt %, 0.8 wt %, 1 wt %, 2 wt %, 4 wt %, 6 wt %, 8 wt %, 10 wt %, or 12 wt %, or from 0.4 to 10 wt % or from 0.6 to 8 wt %, based on the total weight of the antioxidant composition.

In an embodiment, the antioxidant composition of this disclosure is in the form of an aqueous dispersion. In an embodiment, the average particle size (D50) of the aqueous dispersion is no more than 10 μm, or no more than 5 μm, or no more than 2 μm. The dispersion can be a suspension or emulsion.

“The term “particle size” refers to the diameter of particles formed by solid ingredients or diameter of oil droplets formed by liquid ingredients which are dispersed in the continuous phase. Typical particle/droplet size parameters include D10, D50, D90. The term “median particle size” or “average particle size” refers to D50 value where 50% by volume of the particles/droplets have diameters that are smaller or equivalent to the D50 value. The average particle size is measured with Malvern Mastersizer 2000 spectrometer and recorded as median particle size (D50) in microns by diluting 1.0 ml sample in 40 ml of deionized water.

In an embodiment, antioxidant composition comprises
2 to 60 wt % of component (a);
2 to 60 wt % of component (b);
0 to 40 wt % or 2 to 40 wt % of a hindered phenol;
0 to 30 wt % or 2 to 30 wt % of a thiosynergist;
0.2 to 12 wt % of a protective colloid and/or a surfactant; and
water: the remainder to 100 wt %,
in each case based on the total weight of the antioxidant composition.

In an embodiment, antioxidant composition comprises
5 to 50 wt % of component (a);
5 to 50 wt % of component (b);
0 to 30 wt % or 2 to 30 wt % of a hindered phenol;
0 to 25 wt % or 2 to 25 wt % of a thiosynergist;
0.4 to 10 wt % of a protective colloid and/or a surfactant; and
water: the remainder to 100 wt %,
in each case based on the total weight of the antioxidant composition.

In an embodiment, antioxidant composition comprises
6 to 40 wt % of component (a);
6 to 40 wt % of component (b);
0 to 30 wt % or 2 to 30 wt % of a hindered phenol;
0 to 20 wt % or 2 to 20 wt % of a thiosynergist;
0.6 to 8 wt % of a protective colloid and/or a surfactant; and
water: the remainder to 100 wt %,
in each case based on the total weight of the antioxidant composition.

In an embodiment, antioxidant composition comprises
8 to 30 wt % of component (a);
8 to 30 wt % of component (b);
0 to 30 wt % or 2 to 30 wt % of a hindered phenol;
0 to 20 wt % or 2 to 20 wt % of a thiosynergist;
0.6 to 8 wt % of a protective colloid and/or a surfactant; and
water: the remainder to 100 wt %,
in each case based on the total weight of the antioxidant composition.

The antioxidant composition of this disclosure can further comprise other additives, such as a epoxidized vegetable oil. The epoxidized vegetable oil is present not greater than 20 wt % based on weight of the antioxidant composition, preferably in a range from 0 to 15 wt %, more preferably in a range from 0 to 10 wt % based on weight of the antioxidant composition. An example of the epoxidized vegetable oil is epoxidized soybean oil.

According to the present disclosure, antioxidant composition is substantially free of organic solvent, especially methanol. “Substantially free of organic solvent” means the content of the organic solvent is no more than 5 wt %, preferably no more than 2 wt %, or no more than 1 wt %, or no more than 0.5 wt %, or no more than 0.2 wt %, or no more than 0.1 wt %, or no more than 0.05 wt %, based on the weight of the antioxidant composition.

According to the present disclosure, the pH value of the antioxidant composition is no more than 7.5, or no more than 7.3. The pH value can be measured for example using a Metrohm 744 PH Meter at room temperature.

### Preparing Process, Use and Polymer Composition

In a further aspect, this disclosure provides a process for preparing an aqueous dispersion comprising the antioxidant composition of this disclosure (or the antioxidant composition being in the form of aqueous dispersion), which comprises homogenizing component (a), component (b), optional hindered phenol and optional a thiosynergist, and a protective colloid and/or surfactant in water.

A person skilled in the art could understand that if the antioxidant composition of this disclosure is in the form of aqueous dispersion, “a process for preparing an aqueous dispersion comprising the antioxidant composition of this disclosure” means “a process for preparing the antioxidant composition in the form of aqueous dispersion”.

In an embodiment, when component (a), component (b), hindered phenol or thiosynergist are in solid, the solid components are heated to melt before the homogenization, and the homogenization is carried out in water in the presence of the protective colloid and/or surfactant.

In an embodiment, the protective colloid and/or surfactant is dissolved in water before the homogenization. If both the protective colloid and surfactant are used, then both the protective colloid and surfactant are dissolved in water before the homogenization.

In an embodiment, the homogenization is carried out at elevated temperature, preferably at a temperature higher than the melting points of component (a), component (b), hindered phenol (when present) and thiosynergist (when present).

In a further aspect, this disclosure provides use of the antioxidant composition of this disclosure as chain stopper and/or stabilizer.

Usually, the antioxidant composition of this disclosure can be used as chain stopper and/or stabilizer in free radical polymerization.

As free radical polymerization, examples such as suspension polymerization, micro-suspension polymerization and emulsion polymerization can be mentioned. In the free radical polymerization, a free radical polymerization initiator such as an organic peroxide or an azo compound may be used.

The monomers in the free radical polymerization comprise a free-radically polymerizable group. The free-radically polymerizable group can be selected from allyl, vinyl, acrylate, methacrylate, acryloxy, methacryloxy, acrylamido, methacrylamido or acetylenyl. Usually, the monomer can include vinyl monomers, conjugated diene monomers, acrylic monomers, methacrylic monomers, acrylonitrile and mixtures thereof, especially vinyl chloride, styrene, acrylonitrile, butadiene and (meth)acrylate.

The total dosage of component (a) and component (b) in the free radical polymerization system can be in the range from 20 to 4000 ppm (for example 20 ppm, 30 ppm, 35 ppm, 40 ppm, 50 ppm, 80 ppm, 100 ppm, 200 ppm, 500 ppm, 800 ppm, 1000 ppm, 1500 ppm, 2000 ppm, 3000 ppm or 4000 ppm), preferably from 30 to 2000 ppm, or from 40 to 1000 ppm, or from 45 to 800 ppm, based on the weight of the monomer added in the polymerization system.

In a further aspect, this disclosure provides a polymer composition comprising the antioxidant composition of this disclosure. The polymer can be derived from the monomer as mentioned above, especially is selected from polyvinyl chloride, acrylonitrile butadiene styrene (ABS), methyl methacrylate butadiene styrene (MBS), nitrile-butadiene rubber or styrene-butadiene rubber, etc.

The total amount of the component (a) and component (b) in the polymer composition can be in the range from 20 to 4000 ppm (for example 20 ppm, 30 ppm, 35 ppm, 40 ppm, 50 ppm, 80 ppm, 100 ppm, 200 ppm, 500 ppm, 800 ppm, 1000 ppm, 1500 ppm, 2000 ppm, 3000 ppm or 4000 ppm), preferably from 30 to 2000 ppm, or from 40 to 1000 ppm, or from 45 to 800 ppm, based on the total weight of the polymer composition.

### EXAMPLES

### Materials

Component (a): Vitamin E from BASF (Irganox E 201). It is a phenolic antioxidant and is 2,5,7,8-tetramethyl-2-[4,8,12-trimethyltridecyl]chroman-6-ol, which is depicted below:

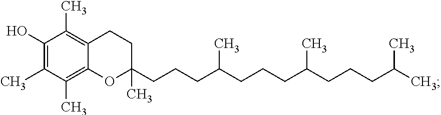 [SMILES: Cc1c(C)c2c(c(C)c1O)CCC(C)(CCCC(C)CCCC(C)CCCC(C)C)O2]

The Irganox E 201 is 100% D,L-α-tocopherol.
Component (b): BHA (Butylated Hydroxy-Anisole) from DANISCO; comprising 90% 3-tert-butyl-4-hydroxyanisole, the sum of 3-tert-butyl-4-hydroxyanisole and 2-tert-butyl-4-hydroxyanisole is 98%;
Protective colloid: Inovol PA8 from Ineos, the degree of hydrolysis: 86-90 mol % (TM/SA/6), viscosity of a 4% aqueous solution (mPa·s): 5-6 (TM/SA/7);
Hindered phenol: Irganox 1076: octadecyl-3-[3,5-di-tert-butyl-4-hydroxyphenyl]propionate from BASF; Wingstay L: butylated products of p-cresol and dicyclopentadiene.
Thiosynergist: Irganox PS 800 FL=DLTDP=Didodecyl-3,3′-thiodipropionate;
Commercial product P: A mixture of 33.3% Irganox 1076, 33.3% DLTDP and 33.3% Wingstay L.

### Test Methods

Pressure Drop: Reading from the Pressure Gauge.
Dehydrochlorination test: This test is based on an equipment which heats PVC resin to 180° C., then HCl is collected to water (i.e., a HCl water solution is obtained), and the conductivity of the HCl water solution is tested to determine how long the conductivity of the HCl water solution can achieve 200mikro Siemens/cm.
Whiteness index: whiteness index was checked on Datacolor SF 600X (color spectrophotometer), wherein the polymer sample was filled in the Petri dish and the surface of the polymer sample was scraped before checking.
D50: Particle size of solid antioxidants and droplet size of liquid antioxidants in the aqueous antioxidant suspoemulsion was measured with Malvern Mastersizer 2000 spectrometer and recorded as median particle size (D50) in microns by diluting 1.0 ml sample in 40 ml of deionized water.

### Example 1: Preparation of Sample 1

1) 2.67 Kg BHA was added into a vessel, heated up to 85° C. and then 1.33 Kg Vitamin E was added and agitated at 25 RPM until completely melted.
2) 3 Kg 20% Poval 8-88 (Polyvinyl alcohol) aqueous solution was added into the vessel under agitation, then the agitator speed was increased to be 75 RPM, and the homogenizer was turned on at 3000 RPM.
3) After 5 mins, the homogenizing speed was further increased to be 6000 RPM to start emulsification.
4) After 1 hour, the average particle size (D50) was checked to see whether it was no more than 2 μm. If not, continuing homogenizing until the average particle size (D50) was no more than 2 μm, the homogenization was then stopped.
5) 3 Kg (30% by weight) deionized water was added and then the mixture was stirred well at 75 RPM to obtain sample 1.

### Example 2: Preparation of Sample 2

1) 1.33 Kg BHA was added into a vessel and heated up to 85° C., and then 2.67 Kg Vitamin E was added and agitated at 25 RPM until completely melted.
2) 3 Kg 20% Polyvinyl alcohol aqueous solution (30% by weight) was added into the vessel under agitation, then the agitator speed was increased to be 75 RPM, and the homogenizer was turned on at 3000 RPM.
3) The homogenizing speed was further increased to be 6000 RPM to start emulsification.
4) After 1 hour, the average particle size was checked to see whether it was no more than 2 μm. If not, continuing homogenizing until the average particle size (D50) was no more than 2 μm, the homogenization was then stopped.
5) 3 Kg (30% by weight) deionized water was added and then the mixture was stirred well at 75 RPM to obtain sample 2.

### Example 3: Preparation of Sample 3

1) Irganox 1076 (10 part by weight), DLTDP (10 part by weight), Wingstay L (10 part by weight), and BHA (5 part by weight) were added into a vessel and heated up to 85° C., and then agitated at 75 RPM until completely melted.
2) The temperature was cooled down to 65° C. and Vitamin E (5 part by weight) was added and stirred well at 75 RPM.
3) 20% polyvinyl alcohol aqueous solution (25 part by weight) was added, and the homogenizer was turned on at 3000 RPM.
4) The homogenizing speed was increased to be 6000 RPM to start emulsification.
5) After 1 hour, the average particle size was checked to see whether it was no more than 2 μm. If not, continuing homogenizing until the average particle size (D50) was no more than 2 μm, the homogenization was then stopped.
6) Deionized water (35 part by weight) was added and then the mixture was stirred at 75 RPM to obtain sample 3.

Examples 4, 5 and comparative examples 1 and 2: PVC polymerization by using samples 1, 2, Vitamin E and BHA, respectively

The experiments were based on K67 grade PVC resin which was polymerized at 57° C. The detailed preparation of polyvinyl chloride was as follows:
(1) 666 g deionized water, 0.250 g Cumyl peroxyneodecanoate (50 wt % in water and methanol), 0.222 g Di(2-ethylhexyl) peroxydicarbonate (50 wt % in water and methanol), 0.8 g of polyvinyl alcohol were mixed in a 2 L polymerization reactor;
(2) The reactor was vacuumized, then 444 g of vinyl chloride monomer was added under stirring and the temperature was increased to 57° C., the internal pressure of the reactor was 9 bar for polymerization;
(3) Samples 1, 2, Vitamin E, or BHA each was added in a dosage as shown in table 1 below when an internal pressure of the reactor decreased to 8 bar (the conversion rate of the monomer is about 85%) wherein the dosages of active in table 1 were based on the vinyl chloride initially added, i.e., 444 g. In examples 4 and 5, the dosages of active related to the sum of Vitamin E and BHA.
(4) The temperature was maintained and the pressure drop was observed for 1.5 hrs and summarized in table 1. Less pressure drop indicated a better chain stopping efficiency (because less further polymerization).
(5) The residual monomers were removed from the obtained polymer slurry, then the polymer slurry was dried to obtain the polyvinyl chloride resin.

The whiteness Index of the PVC resin (Initial) and the Whiteness Index of the PVC resin after being heated at 160° C. for 10 mins were tested and summarized in table 1.

TABLE 1

| | | | Pressure | | Whiteness |
|---|---|---|---|---|---|
| | | Dosage | drop after | Whiteness | Index |
| | | (ppm, | 1.5 hours | Index | (after 160° |
| examples | | active) | (bar) | (Initial) | C., 10 mins) |
| Example 4 | Sample 1 | 50 | 0.55 | 97 | 91 |
| Example 5 | Sample 2 | 50 | 0.75 | 97 | 93 |
| Comparative | Vitamin E | 50 | 1.3 | 92 | 87 |
| Example 1 | | | | | |
| Comparative | BHA | 50 | 0.85 | 97 | 91 |
| Example 2 | | | | | |

Pressure drop results in table 1 showed that the chain stopping effect of the Inventive Samples 1 and 2 are not only better than single Vitamin E but also better than single BHA, which further showed synergistic effect of component (a) and component (b) in terms of chain stopping.

In addition, as indicated by the whiteness index (original), inventive Samples 1 and 2 were much whiter than single Vitamin E. After heating at 160° C. for 10 minss, the whiteness of the polymer of example 5 (Vitamin E:BHA=2:1) was 93 which is higher than both single Vitamin E and single BHA and thereby showed strong synergistic effect in terms of anti-yellowness. Besides, example 4 (Vitamin E:BHA=1:2) also showed relative synergistic effect since its whiteness index (after 160° C., 10 mins), i.e. 91, was much higher than the one mathematically expected, i.e. 1/3*87 (comparative example 1, single VE)+2/3*91 (comparative example 2, single BHA)=89.6.

For the PVC resin obtained in examples 4 and 5, the time when the conductivity of the HCl water solution in the Dehydrochlorination test achieved 200mikro Siemens/cm was 45 min and 46 min, respectively. Longer time indicates less releasing speed of HCl from PVC resin, which means less degradation of PVC resin.

Example 6 and comparative example 3: PVC polymerization by using sample 3 and commercial product P, respectively

The experiments were based on K67 grade PVC resin which was polymerized at 57° C. The detailed preparation of polyvinyl chloride was as follows:
(1) 666 g deionized water, 0.250 g Cumyl peroxyneodecanoate (50 wt % in water and methanol), 0.222 g Di(2-ethylhexyl) peroxydicarbonate (50 wt % in water and methanol), 0.8 g of polyvinyl alcohol were mixed in a 2 L polymerization reactor;
(2) The reactor was vacuumized, then 444 g of vinyl chloride monomer was added under stirring and the temperature was increased to 57° C., the internal pressure of the reactor was 9 bar for polymerization;
(3) Sample 3 or commercial product P each was added in a dosage as shown in table 2 below when an internal pressure of the reactor decreased to 8 bar (the conversion rate of the monomer is about 85%) wherein the dosages of active in table 2 were based on the vinyl chloride initially added, i.e., 444 g. In example 6, the dosages of active related to the sum of Vitamin E, BHA, Irganox 1076, DLTDP and Wingstay L. In comparative example 3, the dosages of active related to the sum of Irganox 1076, DLTDP and Wingstay L.
(4) The temperature was maintained and the pressure drop was observed for 1.5 hrs and summarized in table 2. Less pressure drop indicated a better chain stopping efficiency (because less further polymerization).
(5) The residual monomers were removed from the obtained polymer slurry, then the polymer slurry was dried to obtain the polyvinyl chloride resin.

The whiteness Index of the PVC resin (Initial) and the Whiteness Index of the PVC resin after being heated at 160° C. for 10 mins were tested and summarized in table 2; the results of Dehydrochlorination were also summarized in table 2.

TABLE 2

| | | | Pressure | | Whiteness | Dehydro- |
|---|---|---|---|---|---|---|
| | | Dosage | drop after | Whiteness | Index | chlorina- |
| | | (ppm, | 1.5 hours | Index | (after 160° | tion |
| examples | | active) | (bar) | (Initial) | C., 10 mins) | (mins) |
| Example 6 | Sample 3 | 200 | 0.65 | 97 | 91 | 55 |
| Comparative | Commercial | 200 | 1.05 | 97 | 87 | 50 |
| Example 3 | product P | | | | | |

In example 6, the sum of Vitamin E and BHA was 50 ppm and this example also showed excellent chain stopping property (the pressure drop was only 0.65), which was significantly better than that in comparative example 3 (without Vitamin E and BHA). Results of dehydrochlorination test showed that the active comments in sample 3 further showed synergism effect with respect to the thermal stability of the polymer.

1.-18. (canceled)

19. An antioxidant composition comprising
(a) a derivative of chromanol of formula (I) 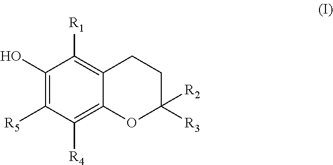
wherein
R₁ is selected from hydrogen, or an aliphatic radical having 1 to 6 carbon atoms;
R₂ is an organic radical having 1 to 30 carbon atoms; and
R₃, R₄, R₅ are selected from, independently of one another, hydrogen or C₁-C₄-alkyl; and
(b) a compound of formula (II) 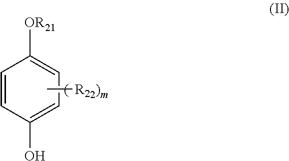
wherein
R₂₁ is C₁-C₆-alkyl,
R₂₂ is C₁-C₈-alkyl, and
m is an integer of 1, 2 or 3, with the proviso that if m is 2 or 3, at most one of the two ortho positions to hydroxyl group carries R₂₂.

20. The antioxidant composition according to claim 19, wherein the composition further comprises a protective colloid and/or surfactant.

21. The antioxidant composition according to claim 19, wherein R₁ is selected from hydrogen or C₁-C₆-alkyl; wherein the C₁-C₆-alkyl can optionally be interrupted by one or more non adjacent sulfur/oxygen atoms, and/or one or more non adjacent carbon atoms in the C₁-C₆-alkyl can optionally be replaced with —(CO)—O—.

22. The antioxidant composition according to claim 19, wherein R₂ is selected from C₁-C₃₀-alkyl, or C₂-C₃₀-alkenyl; wherein the C₁-C₃₀-alkyl can optionally be interrupted by one or more non adjacent sulfur/oxygen atoms, and/or one or more non adjacent carbon atoms in the C₁-C₃₀-alkyl can optionally be replaced with —(CO)—O—.

23. The antioxidant composition according to claim 19, wherein R₃, R₄, R₅ are selected from, independently of one another, hydrogen, methyl or ethyl.

24. The antioxidant composition according to claim 19, wherein component (a) comprises α-, β-, γ-, δ-tocopherol or α-, β-, γ-, δ-tocotrienols, or mixture thereof.

25. The antioxidant composition according to claim 19, wherein
R₂₁ is C₁-C₄-alkyl;
R₂₂ is C₄-C₈ alkyl; and
m is an integer of 1 or 2, with the proviso that if m is 2, at most one of the two ortho positions to hydroxyl group carries R₂₂.

26. The antioxidant composition according to claim 19, wherein component (b) comprises 3-tert-butyl-4-hydroxyanisole and/or 2-tert-butyl-4-hydroxyanisole.

27. The antioxidant composition according to claim 19, wherein the weight ratio of component (a) to component (b) is from 5:1 to 1:5.

28. The antioxidant composition according to claim 19, wherein the composition further comprises a hindered phenol which is different from the compound of formula (I) and the compound of formula (II), a thiosynergist, or combination thereof.

29. The antioxidant composition according to claim 19, wherein the composition is in a form of an aqueous dispersion, and average particle size (D50) of the aqueous dispersion is no more than 10 μm.

30. The antioxidant composition according to claim 20, wherein the composition comprises
2 to 60 wt % or 5 to 50 wt % of component (a);
2 to 60 wt % or 5 to 50 wt % of component (b);
0 to 40 wt % or 2 to 40 wt % of a hindered phenol;
0 to 30 wt % or 2 to 30 wt % of a thiosynergist;
0.2 to 12 wt % or 0.4 to 10 wt % of a protective colloid and/or a surfactant; and
water: the remainder to 100 wt %,
in each case based on the total weight of the antioxidant composition.

31. The antioxidant composition according to claim 19, wherein the composition is substantially free of organic solvent.

32. A process for preparing an aqueous dispersion comprising the antioxidant composition according to claim 19, which comprises homogenizing component (a) and component (b), an optional hindered phenol, an optional thiosynergist, and a protective colloid and/or surfactant in water at elevated temperature.

33. The process according to claim 32, wherein when component (a), component (b), hindered phenol or thiosynergist are in solid, the solid components are heated to melt before the homogenization, and the homogenization is carried out in water in the presence of the protective colloid and/or surfactant.

34. The process according to claim 32, wherein the homogenization is carried out at a temperature higher than the melting points of component (a), component (b), and an optional hindered phenol and an optional thiosynergist.

35. A chain stopper or stabilizer comprising the antioxidant composition according to claim 19.

36. A polymer composition comprising an antioxidant composition according to claim 19.
